(19) United States
(12) Patent Application Publication
(10) Pub. No.: US 2025/0266853 A1
(43) Pub. Date: Aug. 21, 2025

(54) WIRELESS COMMUNICATION DEVICE

(71) Applicant: MEDIATEK INC., Hsinchu City (TW)

(72) Inventors: Chang-Yi HSU, Hsinchu City (TW); Po-Hsun HUANG, Hsinchu City (TW); Chia-Hsuan CHUANG, Hsinchu City (TW); Yi-Yan LI, Hsinchu City (TW); Shen-Yi LIAO, Hsinchu City (TW)

(21) Appl. No.: 18/917,435

(22) Filed: Oct. 16, 2024

Related U.S. Application Data
(60) Provisional application No. 63/555,476, filed on Feb. 20, 2024.
(60) Provisional application No. 63/648,736, filed on May 17, 2024.

(51) Int. Cl. H04B 1/00; H04B 1/44; H04B 7/0404

(52) U.S. Cl. CPC H04B 1/0064; H04B 1/44; H04B 7/0404

(57) ABSTRACT

A wireless communication device is provided. The wireless communication device includes a first radio frequency circuit, a second radio frequency circuit, a third radio frequency circuit, a first antenna, a second antenna, a first switch including a first end, a second end, a third end, and a fourth end, and a second switch including a fifth end, a sixth end, and a seventh end. The first end connects to the first radio frequency circuit. The second end connects to the second radio frequency circuit. The third end connects to the first antenna. The fourth end connects to the fifth end. The sixth end connects to the third radio frequency circuit. The seventh end connects to the second antenna.

### CROSS REFERENCE TO RELATED APPLICATIONS

This application claims priority of U.S. Provisional Application Ser. No. 63/555,476, filed on 2024 Feb. 20 and U.S. Provisional Application Ser. No. 63/648,736, filed on 2024 May 17, the entirety of which are incorporated by reference herein.

### BACKGROUND OF THE INVENTION

### Field of the Invention

The present invention relates to a wireless communication device, and, in particular, it relates to a wireless communication device with multiple radio frequency circuits sharing multiple antennas.

### Description of the Related Art

When a device has more radio frequency circuits than antennas, some radio frequency circuits will have to share an antenna. However, if the connections between the radio frequency circuits and the antennas aren't well-configured, there may be some unused antennas when the radio frequency circuit is idle. Thus, a wireless communication device that can fully use every antenna is required.

### BRIEF SUMMARY OF THE INVENTION

An embodiment of the present invention provides a wireless communication device. The wireless communication device comprises a first radio frequency circuit, a second radio frequency circuit, a third radio frequency circuit, a first antenna, a second antenna, a first switch, and a second switch. The first switch comprises a first end, a second end, a third end, and a fourth end. The second switch comprises a fifth end, a sixth end, and a seventh end. The first end connects to the first radio frequency circuit. The second end connects to the second radio frequency circuit. The third end connects to the first antenna. The fourth end connects to the fifth end. The sixth end connects to the third radio frequency circuit. The seventh end connects to the second antenna. The first switch is configured to connect the first end to the third end and to connect the second end to the fourth end, or to connect the first end to the fourth end and to connect the second end to the third end. The second switch is configured to connect either the fifth end or the sixth end to the seventh end.

### BRIEF DESCRIPTION OF THE DRAWINGS

The present invention can be more fully understood by reading the subsequent detailed description and examples with references made to the accompanying drawings, wherein:

FIG. 1 is a block diagram of a wireless communication device 100 in accordance with the embodiments of the present disclosure;

FIG. 2 is a schematic diagram illustrating one of the embodiments of the present disclosure;

FIG. 3 is a schematic diagram illustrating one of the embodiments of the present disclosure;

FIG. 4 is a schematic diagram illustrating one of the embodiments of the present disclosure;

FIG. 5 is a schematic diagram illustrating one of the embodiments of the present disclosure;

FIG. 6 is a block diagram of the wireless communication device in accordance with the embodiments of the present disclosure;

FIG. 7 is a block diagram of the wireless communication device in accordance with the embodiments of the present disclosure; and

### DETAILED DESCRIPTION OF THE INVENTION

The following description is made for the purpose of illustrating the general principles of the invention and should not be taken in a limiting sense. The scope of the invention is best determined by reference to the appended claims.

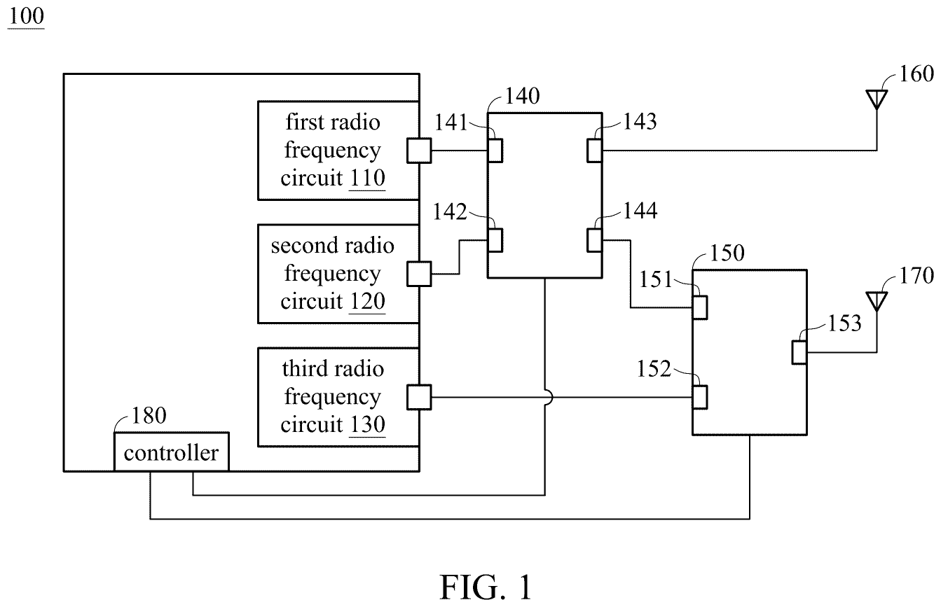

Refer to FIG. 1, FIG. 1 is a block diagram of a wireless communication device 100 in accordance with the embodiments of the present disclosure. The wireless communication device 100 comprises a first radio frequency circuit 110, a second radio frequency circuit 120, a third radio frequency circuit 130, a first switch 140, a second switch 150, a first antenna 160, a second antenna 170, and a controller 180. The wireless communication device 100 may be incorporated or implemented in a cell phone, a tablet computer, a notebook computer, a desktop computer, a wearable device, or an internet of thing device.

The first radio frequency circuit 110, the second radio frequency circuit 120, and the third radio frequency circuit 130 are configured to generate, process, transmit, or receive radio frequency signals. In some embodiments, the first radio frequency circuit 110, the second radio frequency circuit 120, and the third radio frequency circuit 130 may comprise a filter, a modulator, a demodulator, an oscillator, and an amplifier. In some embodiments, the first radio frequency circuit 110, the second radio frequency circuit 120, and the third radio frequency circuit 130 are radio frequency integrated circuits or chips. In some embodiments, the first radio frequency circuit 110, the second radio frequency circuit 120, and the third radio frequency circuit 130 may respectively apply different wireless communication technologies or protocols, such as Wi-Fi, Bluetooth, or thread.

The first switch 140 comprises a first end 141, a second end 142, a third end 143, and a fourth end 144. The first switch 140 is configured to connect the first end 141 to the third end 143 and to connect the second end 142 to the fourth end 144, or to connect the first end 141 to the fourth end 144 and to connect the second end 142 to the third end 143. In other words, the first switch 140 is able to switch between two connection modes. One is to connect the first end 141 to the third end 143 and to connect the second end 142 to the fourth end 144. Another one is to connect the first end 141 to the fourth end 144 and to connect the second end 142 to the third end 143. In some embodiments, the first switch 140 is a double pole double throw (DPDT) switch.

The second switch 150 comprises a fifth end 151, a sixth end 152, and a seventh end 153. The second switch 150 is configured to connect either the fifth end 151 or the sixth end 152 to the seventh end 153 (i.e. to connect one of the fifth end 151 and the sixth end 152 to the seventh end 153). In other words, the second switch 150 is able to switch between two connection modes. One is to connect the fifth end 151 to the seventh end 153. Another one is to connect the sixth end 152 to the seventh end 153. In some embodiments, the second switch 150 is a single pole double throw (SPDT) switch.

The first antenna 160 and the second antenna 170 are configured to transmit or receive signals wirelessly. The controller 180 is configured to control the first switch 140 and the second switch 150. For example, the controller 180 may control the first switch 140 and the second switch 150 to switch to one of the connection modes. In some embodiments, the first radio frequency circuit 110, the second radio frequency circuit 120, or the third radio frequency circuit 130 is configured to control the controller 180. In other words, one of the first radio frequency circuit 110, the second radio frequency circuit 120, and the third radio frequency circuit 130 may be configured to control the controller 180. As a non-limiting example, the second radio frequency circuit 120 may be configured to control the controller 180. The second radio frequency circuit 120 may receive information from the first radio frequency circuit 110 and the third radio frequency circuit 130 and determine the connection modes of the first switch 140 and the second switch 150 based on the information. In some embodiments, the information comprises the state (e.g. active, idle, on, or, off) of the radio frequency circuit, or the signal strength (e.g. received signal strength indication (RSSI), reference signal received power (RSRP), or other indicator) measured at the radio frequency circuit. In some embodiments, the radio frequency circuit which is configured to control the controller 180 may determine the connection mode based on the RSSI of the first antenna 160 and the second antenna 170, so as to connect the radio frequency circuit which requires high data rate (e.g. Wi-Fi) to the antenna with high RSSI. In this way, higher performance can be achieved.

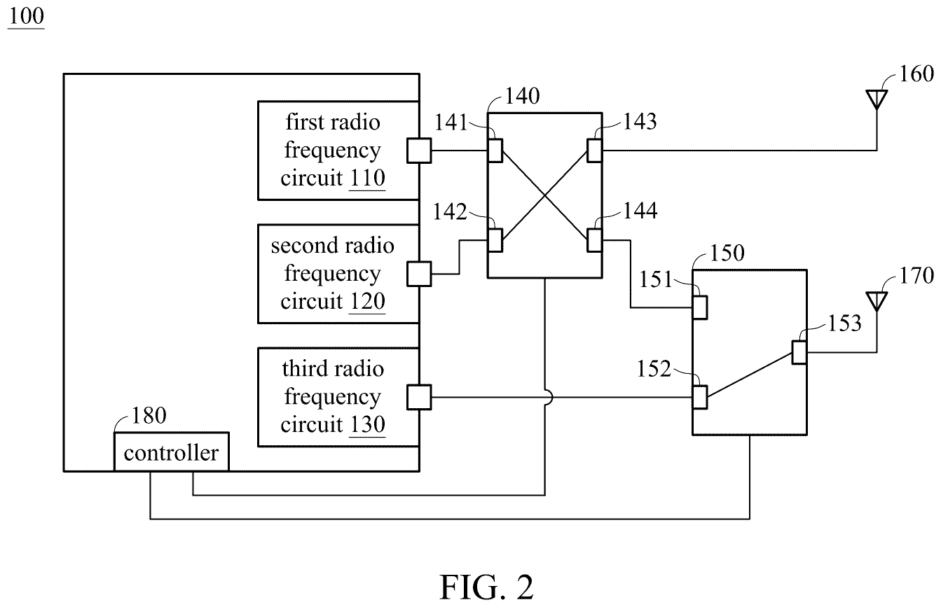

Refer to FIG. 2, FIG. 2 is a schematic diagram illustrating one of the embodiments of the present disclosure. The embodiment shown in FIG. 2 may be applied or used in a scenario that the first radio frequency circuit 110 is turned off or idle. In the embodiment shown in FIG. 2, the first switch 140 is configured to connect the first end 141 to the fourth end 144 and to connect the second end 142 to the third end 143. The second switch 150 is configured to connect the sixth end 152 to the seventh end 153. As a result, the second radio frequency circuit 120 is connected to the first antenna 160 through the first switch 140, and the third radio frequency circuit 130 is connected to the second antenna 170 through the second switch 150. The second radio frequency circuit 120 is configured to transmit or receive signals (such as a first signal) through the first antenna 160. The third radio frequency circuit 130 is configured to transmit or receive signals (such as a second signal) through the second antenna 170. In some embodiments, the second radio frequency circuit 120 and the third radio frequency circuit 130 are configured to transmit or receive signals using a frequency-division duplexing (FDD) way. In some embodiments, the second radio frequency circuit 120 and the third radio frequency circuit 130 are configured to transmit or receive signals using a 2×2 multiple-input multiple-output (MIMO).

Alternatively, the embodiment shown in FIG. 2 may be applied or used in a scenario that the received signal strength indication (RSSI) measured at the first radio frequency circuit 110 is higher than a threshold. In this scenario, the first radio frequency circuit 110 is configured to receive signals (such as a first signal) through the first antenna 160 or the second antenna 170. The second radio frequency circuit 120 is configured to transmit or receive signals (such as a second signal) through the first antenna 160. The third radio frequency circuit 130 is configured to transmit or receive signals (such as a third signal) through the second antenna 170.

Specifically, comparing to the situation that the first end 141 connects to the third end 143, the signal may experience a larger loss (or decline) when transmitted from the third end 143 to the first end 141 in the situation that the first end 141 doesn't connect to the third end 143. However, although the signal may experience a large loss, the signal can still be transmitted from the third end 143 to the first end 141 if only the power of the signal is large enough. Similarly, the signal can still be transmitted from the seventh end 153 to the fifth end 151 if only the power of the signal is large enough. Thus, when the RSSI measured at the first radio frequency circuit 110 is large, the first radio frequency circuit 110 can receive signals (such as leakage signals) through the first antenna 160 or the second antenna 170, even the first end 141 doesn't connect to the third end 143 and even the seventh end 153 doesn't connect to the fifth end 151.

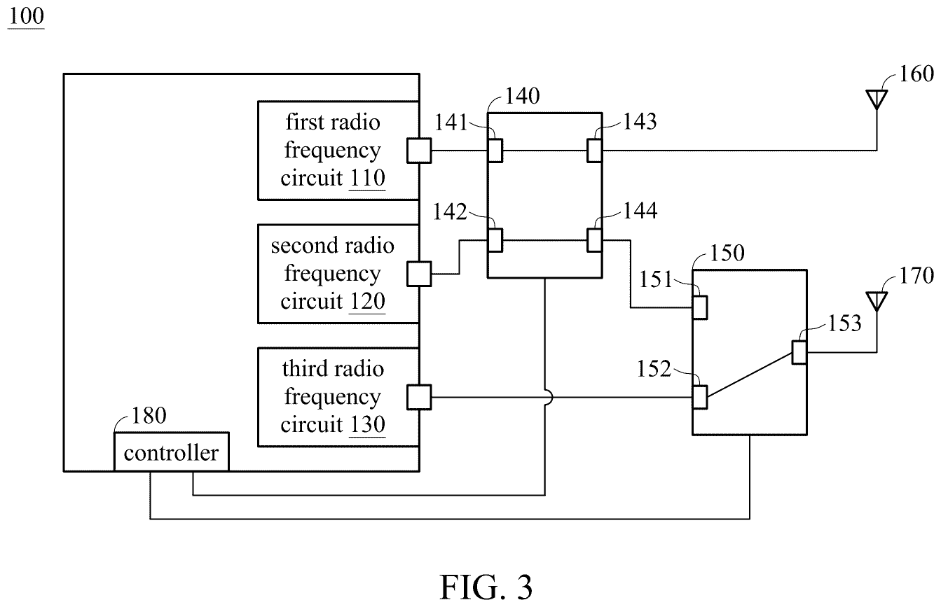

Refer to FIG. 3, FIG. 3 is a schematic diagram illustrating one of the embodiments of the present disclosure. The embodiment shown in FIG. 3 may be applied or used in a scenario that the second radio frequency circuit 120 is turned off or idle. In the embodiment shown in FIG. 3, the first switch is configured to connect the first end 141 to the third end 143 and to connect the second end 142 to the fourth end 144. The second switch 150 is configured to connect the sixth end 152 to the seventh end 153. As a result, the first radio frequency circuit 110 is connected to the first antenna 160 through the first switch 140, and the third radio frequency circuit 130 is connected to the second antenna 170 through the second switch 150. The first radio frequency circuit 110 is configured to transmit or receive signals (such as a first signal) through the first antenna 160. The third radio frequency circuit 130 is configured to transmit or receive signals (such as a second signal) through the second antenna 170. In some embodiments, the first radio frequency circuit 110 and the third radio frequency circuit 130 are configured to transmit or receive signals using a FDD way. In some embodiments, the first radio frequency circuit 110 and the third radio frequency circuit 130 are configured to transmit or receive signals using a 2×2 MIMO.

Alternatively, the embodiment shown in FIG. 3 may be applied or used in a scenario that the RSSI measured at the second radio frequency circuit 120 is higher than a threshold. In this scenario, the first radio frequency circuit 110 is configured to transmit or receive signals (such as a first signal) through the first antenna 160. The second radio frequency circuit 120 is configured to receive signals (such as a second signal) through the first antenna 160 or the second antenna 170 (the leakage signal). The third radio frequency circuit 130 is configured to transmit or receive signals (such as a third signal) through the second antenna 170.

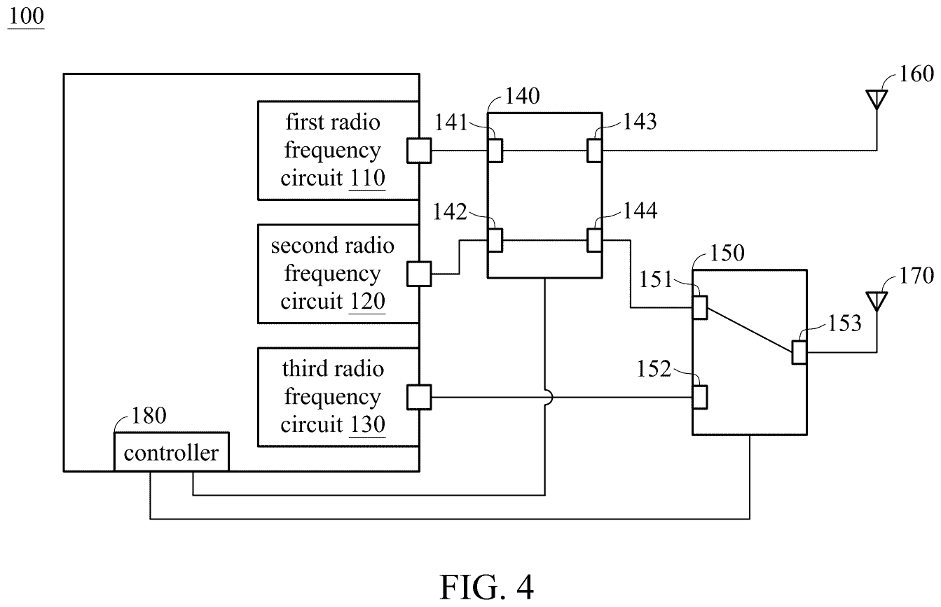

Refer to FIG. 4, FIG. 4 is a schematic diagram illustrating one of the embodiments of the present disclosure. The embodiment shown in FIG. 4 may be applied or used in a scenario that the third radio frequency circuit 130 is turned off or idle. In the embodiment shown in FIG. 4, the first switch 140 is configured to connect the first end 141 to the third end 143 and to connect the second end 142 to the fourth end 144. The second switch 150 is configured to connect the fifth end 151 to the seventh end 153. As a result, the first radio frequency circuit 110 is connected to the first antenna 160 through the first switch 140, and the second radio frequency circuit 120 is connected to the second antenna 170 through the first switch 140 and the second switch 150. The first radio frequency circuit 110 is configured to transmit or receive signals (such as a first signal) through the first antenna 160. The second radio frequency circuit 120 is configured to transmit or receive signals (such as a second signal) through the second antenna 170. In some embodiments, the first radio frequency circuit 110 and the second radio frequency circuit 120 are configured to transmit or receive signals using a FDD way. In some embodiments, the first radio frequency circuit 110 and the second radio frequency circuit 120 are configured to transmit or receive signals using a 2×2 MIMO.

Alternatively, the embodiment shown in FIG. 4 may be applied or used in a scenario that the RSSI measured at the third radio frequency circuit 130 is higher than a threshold. In this scenario, the first radio frequency circuit 110 is configured to transmit or receive signals (such as a first signal) through the first antenna 160. The second radio frequency circuit 120 is configured to transmit or receive signals (such as a second signal) through the second antenna 170. The third radio frequency circuit 130 is configured to receive signals (such as a third signal) through the second antenna 170 (the leakage signal).

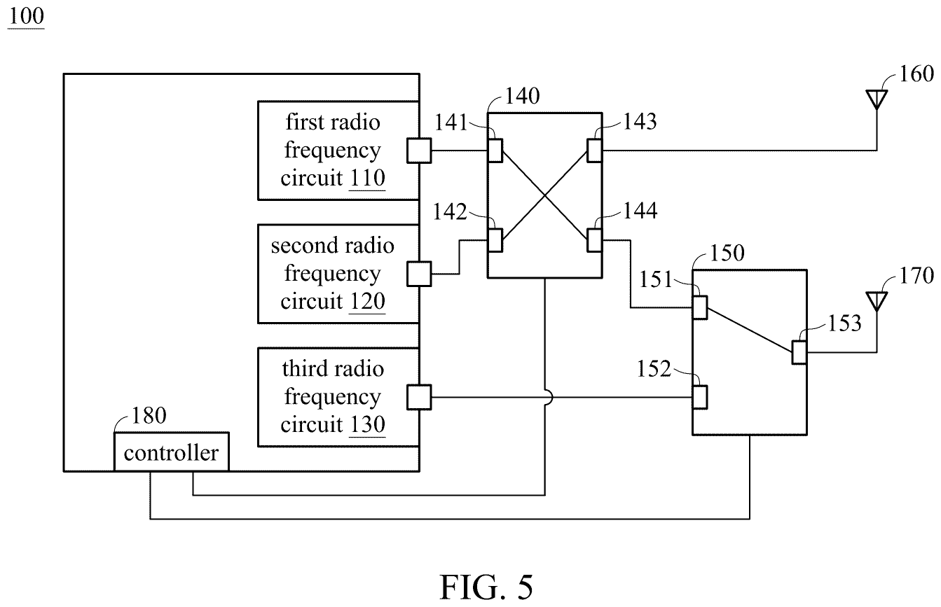

Refer to FIG. 5, FIG. 5 is a schematic diagram illustrating one of the embodiments of the present disclosure. The embodiment shown in FIG. 5 may be applied or used in a scenario that the third radio frequency circuit 130 is turned off or idle. In the embodiment shown in FIG. 5, the first switch 140 is configured to connect the first end 141 to the fourth end 144 and to connect the second end 142 to the third end 143. The second switch 150 is configured to connect the fifth end 151 to the seventh end 153. As a result, the first radio frequency circuit 110 is connected to the second antenna 170 through the first switch 140 and the second switch 150, and the second radio frequency circuit 120 is connected to the first antenna 160 through the first switch 140. The first radio frequency circuit 110 is configured to transmit or receive signals (such as a first signal) through the second antenna 170. The second radio frequency circuit 120 is configured to transmit or receive signals (such as a second signal) through the first antenna 160. In some embodiments, the first radio frequency circuit 110 and the second radio frequency circuit 120 are configured to transmit or receive signals using a FDD way. In some embodiments, the first radio frequency circuit 110 and the second radio frequency circuit 120 are configured to transmit or receive signals using a 2×2 MIMO.

Alternatively, the embodiment shown in FIG. 5 may be applied or used in a scenario that the RSSI measured at the third radio frequency circuit 130 is higher than a threshold. In this scenario, the first radio frequency circuit 110 is configured to transmit or receive signals (such as a first signal) through the second antenna 170. The second radio frequency circuit 120 is configured to transmit or receive signals (such as a second signal) through the first antenna 160. The third radio frequency circuit 130 is configured to receive signals (such as a third signal) through the second antenna 170 (the leakage signal).

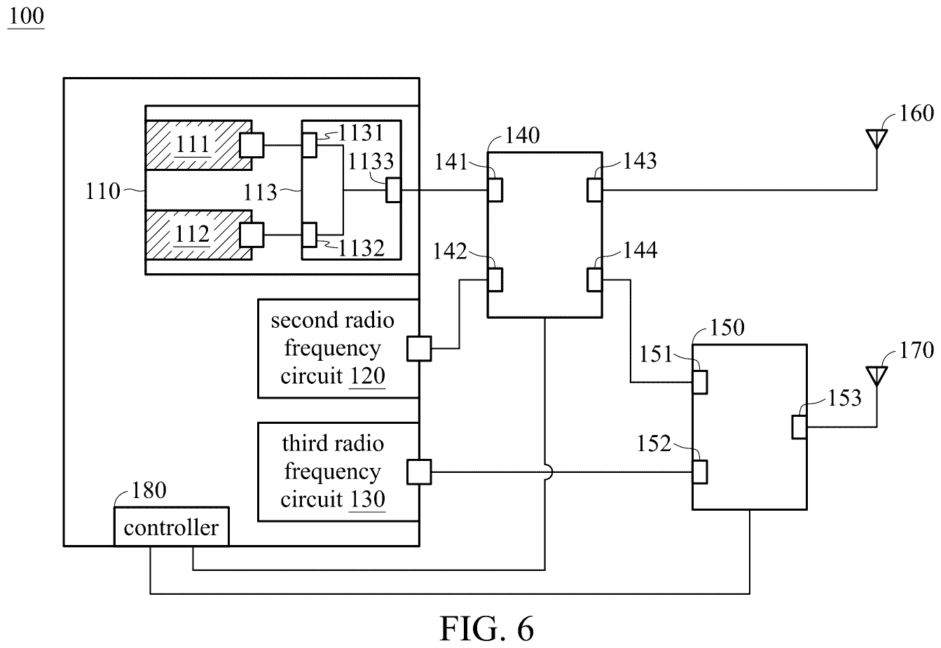

Refer to FIG. 6, FIG. 6 is a block diagram of the wireless communication device 100 in accordance with the embodiments of the present disclosure. In the embodiment shown in FIG. 6, the first radio frequency circuit 110 comprises a first communication module 111, a second communication module 112, and a diplexer 113. The diplexer 113 comprises a first diplexer input end 1131, a second diplexer input end 1132, and a diplexer output end 1133. The first diplexer input end 1131 and the second diplexer input end 1132 connect to the diplexer output end 1133. The first communication module 111 connects to the first diplexer input end 1131. The second communication module 112 connects to the second diplexer input end 1132. The diplexer output end 1133 connects to the first end 141 of the first switch 140.

The first communication module 111 and the second communication module 112 are configured to generate, process, transmit, or receive radio frequency signals. In some embodiments, the first communication module 111 and the second communication module 112 correspond to different bands. For example, the first communication module 111 and the second communication module 112 correspond to different Wi-Fi bands (such as 2.4 GHZ, and 5 GHz). In other words, the frequencies of the signals transmitted or received through the first communication module 111 and the second communication module 112 may be different. In some embodiments, the first communication module 111 and the second communication module 112 are hardware circuits or modules incorporated in the first radio frequency circuit 110.

The diplexer 113 is configured to combine the signals from the first diplexer input end 1131 and the second diplexer input end 1132 to generate a combined signal and output the combined signal on the diplexer output end 1133. The diplexer 113 is further configured to separate the signal from the diplexer output end 1133 to generate two signals and respectively output the two signal on the first diplexer input end 1131 and the second diplexer input end 1132.

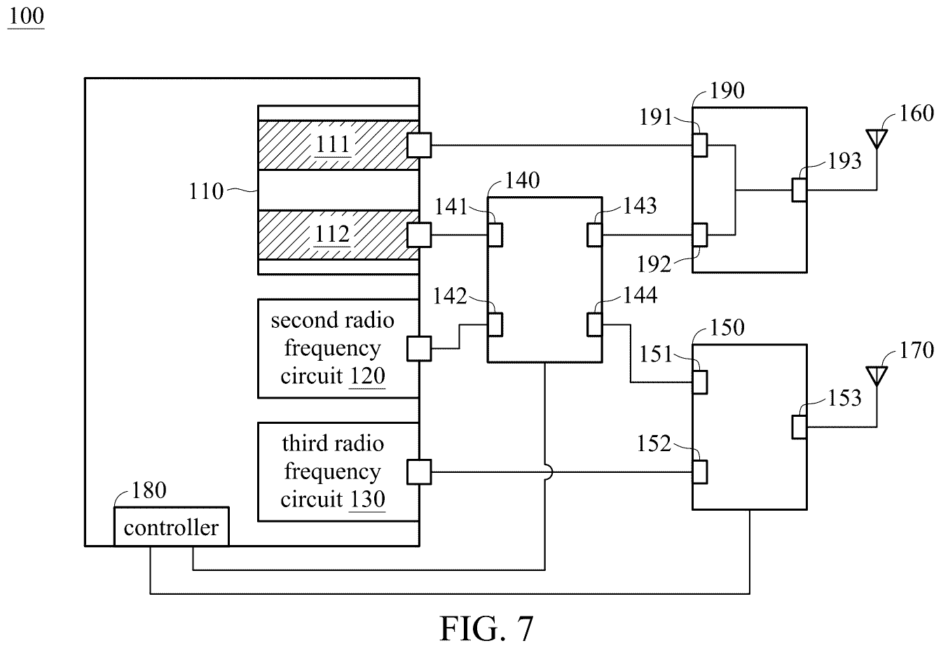

Refer to FIG. 7, FIG. 7 is a block diagram of the wireless communication device 100 in accordance with the embodiments of the present disclosure. In the embodiment shown in FIG. 7, the wireless communication device 100 further comprises a diplexer 190. The diplexer 190 comprises a first diplexer input end 191, a second diplexer input end 192, and a diplexer output end 193. The first diplexer input end 191 and the second diplexer input end 192 connect to the diplexer output end 193. Moreover, the first radio frequency circuit 110 comprises a first communication module 111 and a second communication module 112. The first communication module 111 connects to the first diplexer input end 191. The second communication module 112 connects to the first end 141 of the first switch 140. The third end 143 of the first switch 140 connects to the second diplexer input end 192, and the diplexer output end 193 connects to the first antenna 160. Thus, the first radio frequency circuit 110 and the first switch 140 connects to the first antenna 160 through the diplexer 190. The first communication module 111 and the second communication module 112 have been described refer to FIG. 6. Furthermore, the diplexer 190 is similar to the diplexer 113 in FIG. 6.

The wireless communication device in accordance to embodiments of the present disclosure can fully use every antenna even when some of the radio frequency circuits are idle or turned off. When some of the radio frequency circuits are idle or turned off, the antenna can connect to other active radio frequency circuits through the switches. It should be noted that the present invention is not limited to the case that three radio frequency circuits share two antennas but is able to applied to the case that N radio frequency circuits share M antennas (N>M).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wireless communication device, comprising:
a first radio frequency circuit;
a second radio frequency circuit;
a third radio frequency circuit;
a first antenna;
a second antenna;
a first switch, comprising a first end, a second end, a third end, and a fourth end; and
a second switch, comprising a fifth end, a sixth end, and a seventh end;
wherein:
the first end connects to the first radio frequency circuit;
the second end connects to the second radio frequency circuit;
the third end connects to the first antenna;
the fourth end connects to the fifth end;
the sixth end connects to the third radio frequency circuit;
the seventh end connects to the second antenna;
the first switch is configured to connect the first end to the third end and to connect the second end to the fourth end, or to connect the first end to the fourth end and to connect the second end to the third end; and
the second switch is configured to connect the fifth end or the sixth end to the seventh end.

2. The wireless communication device as claimed in claim 1, wherein when the first radio frequency circuit is turned off or idle:
the first switch is configured to connect the first end to the fourth end and to connect the second end to the third end;
the second switch is configured to connect the sixth end to the seventh end;
the second radio frequency circuit is configured to transmit or receive a first signal through the first antenna; and
the third radio frequency circuit is configured to transmit or receive a second signal through the second antenna.

3. The wireless communication device as claimed in claim 1, wherein when the received signal strength indication (RSSI) measured at the first radio frequency circuit is higher than a threshold:
the first switch is configured to connect the first end to the fourth end and to connect the second end to the third end;
the second switch is configured to connect the sixth end to the seventh end;
the first radio frequency circuit is configured to receive a first signal through the first antenna or the second antenna;
the second radio frequency circuit is configured to transmit or receive a second signal through the first antenna; and
the third radio frequency circuit is configured to transmit or receive a third signal through the second antenna.

4. The wireless communication device as claimed in claim 1, wherein when the second radio frequency circuit is turned off or idle:
the first switch is configured to connect the first end to the third end and to connect the second end to the fourth end;
the second switch is configured to connect the sixth end to the seventh end;
the first radio frequency circuit is configured to transmit or receive a first signal through the first antenna; and
the third radio frequency circuit is configured to transmit or receive a second signal through the second antenna.

5. The wireless communication device as claimed in claim 1, wherein when the received signal strength indication (RSSI) measured at the second radio frequency circuit is higher than a threshold:
the first switch is configured to connect the first end to the third end and to connect the second end to the fourth end;
the second switch is configured to connect the sixth end to the seventh end;
the first radio frequency circuit is configured to transmit or receive a first signal through the first antenna;
the second radio frequency circuit is configured to receive a second signal through the first antenna or the second antenna; and
the third radio frequency circuit is configured to transmit or receive a third signal through the second antenna.

6. The wireless communication device as claimed in claim 1, wherein when the third radio frequency circuit is turned off or idle:
the first switch is configured to connect the first end to the third end and to connect the second end to the fourth end;
the second switch is configured to connect the fifth end to the seventh end;
the first radio frequency circuit is configured to transmit or receive a first signal through the first antenna; and
the second radio frequency circuit is configured to transmit or receive a second signal through the second antenna.

7. The wireless communication device as claimed in claim 1, wherein when the received signal strength indication (RSSI) measured at the third radio frequency circuit is higher than a threshold:
the first switch is configured to connect the first end to the third end and to connect the second end to the fourth end;
the second switch is configured to connect the fifth end to the seventh end;
the first radio frequency circuit is configured to transmit or receive a first signal through the first antenna;
the second radio frequency circuit is configured to receive a second signal through the second antenna; and
the third radio frequency circuit is configured to receive a third signal through the second antenna.

8. The wireless communication device as claimed in claim 1, wherein when the third radio frequency circuit is turned off or idle:
the first switch is configured to connect the first end to the fourth end and to connect the second end to the third end;
the second switch is configured to connect the fifth end to the seventh end;
the first radio frequency circuit is configured to transmit or receive a first signal through the second antenna; and
the second radio frequency circuit is configured to transmit or receive a second signal through the first antenna.

9. The wireless communication device as claimed in claim 1, wherein when the received signal strength indication (RSSI) measured at the third radio frequency circuit is higher than a threshold:
the first switch is configured to connect the first end to the fourth end and to connect the second end to the third end;
the second switch is configured to connect the fifth end to the seventh end;
the first radio frequency circuit is configured to transmit or receive a first signal through the second antenna;
the second radio frequency circuit is configured to transmit or receive a second signal through the first antenna; and
the third radio frequency circuit is configured to receive a third signal through the second antenna.

10. The wireless communication device as claimed in claim 1, wherein the first radio frequency circuit comprises:
a diplexer, comprising a first diplexer input end, a second diplexer input end, and a diplexer output end, wherein the first diplexer input end and the second diplexer input end connect to the diplexer output end;
a first communication module, connected to the first diplexer input end; and
a second communication module, connected to the second diplexer input end;
wherein the diplexer output end connects to the first end of the first switch.

11. The wireless communication device as claimed in claim 1, further comprising:
a diplexer, comprising a first diplexer input end, a second diplexer input end, and a diplexer output end, wherein the first diplexer input end and the second diplexer input end connect to the diplexer output end;
wherein the first radio frequency circuit comprises:
a first communication module, connected to the first diplexer input end; and
a second communication module, connected to the first end of the first switch;
wherein the third end of the first switch connects to the second diplexer input end, and the diplexer output end connects to the first antenna.

12. The wireless communication device as claimed in claim 1, further comprising:
a controller, configured to control the first switch and the second switch.

13. The wireless communication device as claimed in claim 12, wherein the first radio frequency circuit, second radio frequency circuit, or third radio frequency circuit is configured to control the controller.

14. The wireless communication device as claimed in claim 1, wherein the first switch is a double pole double throw (DPDT) switch, and the second switch is a single pole double throw (SPDT) switch.
